(19) United States
(12) Patent Application Publication
(10) Pub. No.: US 2003/0042191 A1
(43) Pub. Date: Mar. 6, 2003

(54) Manifold adapted for replaceable fluid filter cartridge

(76) Inventors: Young Sik Nam, Suwon City (KR); Soon Tae Kim, Uiwang City (KR)

Correspondence Address: CHA & REITER, 411 Hackensack Ave, 9th Floor, Hackensack, NJ, 07601, US

(21) Appl. No.: 10/191,907

(22) Filed: Jul. 9, 2002

(30) Foreign Application Priority Data
Aug. 29, 2001 (KR) 2001-52595

(51) Int. Cl. B01D 35/147; B01D 35/157

(52) U.S. Cl. 210/234; 210/249; 210/420; 210/443

(57) ABSTRACT

Disclosed is a manifold for a replaceable fluid filter cartridge. The manifold possesses inlet and outlet passages and a housing. A first valve assembly is provided in the inlet passage. The housing is provided with first and second fitting mechanisms which have second and third valve assemblies. Fitting portions of the first and second fitting mechanisms are fitted into outer and inner flanges of the filter cartridge. Upon coupling the filter cartridge to the manifold, a valve stem of the second valve assembly is positioned on an upper end surface of the inner flange, and thereby a flow channel is defined. Thus, fluid flows through the inlet passage into the filter cartridge. Upon decoupling the filter cartridge from the manifold, the valve stem of the second valve assembly is separated from the upper end surface of the inner flange to shut off fluid flow from the inlet passage into the filter cartridge. Also, as the second fitting mechanism is removed from the inner flange, a flow path extending between the filter cartridge and a reservoir of the housing is blocked. And, the second valve assembly opens another flow path which directly connects the inlet passage to the reservoir. Therefore, even when the filter cartridge is decoupled from the manifold, fluid can be continuously introduced through the inlet passage into the reservoir of the housing.

### BACKGROUND OF THE INVENTION

1. Field of the Invention

The present invention relates to a manifold to which a replaceable fluid filter cartridge constituting a part of a water purification system is coupled, and more particularly, the present invention relates to a manifold in which inlet and outlet passages are defined in the shape of conduits and fluid-flow controlling devices are provided in the conduits, thereby preventing leakage from water supply lines upon changing the filter cartridge.

2. Description of the Related Art

With the development of living appliances used at home or in offices, etc., demand for water purification and filtration systems to be used in a state wherein they are coupled to the appliances has been gradually increased. A water purification or filtration device serving as one main component element of such water purification and filtration systems typically adopts a replaceable filter cartridge. In this regard, it is the norm that filter cartridges are formed each to have a single or unitary port having multiple flow channels therein, and this type of filter cartridges are disclosed in U.S. Pat. Nos. 4,915,831, 5,336,406 and 5,354,464.

A connecting device or manifold serving as another main component element of the water purification and filtration system functions to receive and transfer fluid such as water to the filter cartridge and direct filtered fluid to desired places inside the appliance. Each of the connecting devices or manifolds such as disclosed in U.S. Pat. Nos. 4,915,831, 5,336,406 and 5,753,107 is provided with a single inlet port and a single outlet port, and the connecting device or manifold such as disclosed in U.S. Pat. No. 5,354,464 is provided with multiple ports.

Meanwhile, it is necessary to periodically change the filter cartridge used in the water purification and filtration system. In this connection, a problem is caused in that leakage may occur in water supply lines upon changing the filter cartridge. In order to prevent leakage from water supply lines upon changing a filter cartridge, as described in U.S. Pat. No. 5,753,107, a flow control valving must be provided to a manifold or the filter cartridge. As the case may be, the filter cartridge can be inadvertently decoupled from a connecting device to cause water leakage. Solutions to cope with this problem are disclosed in U.S. Pat. Nos. 4,915,831 and 5,336,406.

Due to the fact that the conventional water purification and filtration system adopts a configuration that, by rotating the filter cartridge in one direction relative to the connecting device, they are coupled to each other, and by rotating the filter cartridge in the other direction, they are decoupled from each other, coupling and decoupling of the filter cartridge and connecting device to and from each other can be easily effected. In order to ensure that water is supplied from a water supply source such as waterworks or a water tank to the connecting device and flows through the filter cartridge, and filtered water is directed again through the connecting device to a desired place (for example, an ice making section of a refrigerator), a conduit such as a pipe should be provided to join the connecting device and the water supply source with each other. In the conventional art, disadvantages are caused in that, since a screwed type pipe fitting structure is adopted in which pipes are threadedly joined to ports of the connecting device, it is cumbersome and time-consuming to connect, using pipes, an inlet port of the connecting device with the water supply source and an outlet port of the connecting device with the desired place. Because the connecting device and the pipes are joined with each other in this way, when it is necessary to change the pipes due to aging, damage, etc., laborious work must be carried out.

Moreover, in the conventional connecting device, it is considered as an essential point to define inlet and outlet passages for receiving water from the water supply source, transferring water to the filter cartridge and directing the filtered water to the desired place. Therefore, it is difficult to install on the manifold itself a fluid-flow shutoff valve for preventing water leakage upon changing the filter cartridge. Also, even in the case that the fluid-flow shutoff valve is installed on the manifold, the connecting device and the filter cartridge must be designed in such a way as to structurally interact with each other.

Further, in the case that the conventional water purification and filtration system is used in an ice making apparatus, when an amount of fluid flowing through fluid supply lines is decreased due to interruption of fluid supply as it occurs where the filter cartridge is changed with new one, unless fluid flow to the ice making apparatus is completely shut off, defects may result from freezing of water. That is to say, when the filter cartridge is decoupled from the connecting device and thereby fluid supply from the water supply source is interrupted, if fluid flow to the ice making apparatus is not completely shut off and even a small amount of water continuously flows into the ice making apparatus, the fluid supply lines are likely to be frozen, which adversely influences surrounding arrangements.

### SUMMARY OF THE INVENTION

Accordingly, the present invention has been made in an effort to solve the problems occurring in the related art, and an object of the present invention is to provide a pipe or tube connecting structure in which inlet and outlet passages of a manifold are defined by conduits having the shape of pipes or tubes, and the manifold and external pipes are easily jointed with and disjointed from each other.

Another object of the present invention is to provide a manifold in which fluid is allowed to be introduced into and discharged from a housing of the manifold through inlet and outlet passages of the manifold, having the shape of conduits, in a manner such that valve devices can be easily installed on the conduits extending outward from the housing of the manifold.

Another object of the present invention is to provide a manifold in which inlet and outlet passages extending outward from a housing of the manifold are designed to have separate ports or chambers to be connected with valve devices, thereby performing a function of a multi-port connecting device.

Another object of the present invention is to provide a manifold in which a chamber or a reservoir is formed in a housing of the manifold to store a predetermined amount of fluid, thereby managing a fluid amount variation resulting from a fluid pressure change.

Another object of the present invention is to provide a flow control unit which can control a flow rate of fluid supplied from a reservoir defined in a housing of a manifold to an outlet passage, in response to a fluid amount variation in the reservoir.

Another object of the present invention is to provide a manifold which can prevent leakage out of fluid supply lines upon changing a filter cartridge, and a filter cartridge which is coupled to the manifold.

Another object of the present invention is to provide a manifold which, in the case of being used along with an ice making apparatus, completely shuts off fluid flow to the ice making apparatus when fluid supply is interrupted as it occurs where a filter cartridge is changed with new one, thereby preventing conduits and surrounding arrangements from being damaged due to freezing of water.

Still another object of the present invention is to provide a manifold in which a fitting mechanism for coupling the manifold with a filter cartridge is formed to have a double structure so that fluid supply can be continuously effected through fluid supply lines even when a filter cartridge is decoupled from the manifold.

Yet still another object of the present invention is to provide a filter cartridge which, in correspondence to a manifold having a fitting mechanism of a double structure, has a double-staged flange capable of opening and closing a valve of a valve assembly provided to the double-structured fitting mechanism when the manifold and filter cartridge are coupled with and decoupled from each other, respectively.

The above-described objects and other advantages are achieved by a manifold according to the present invention, which constitutes a water purification and filtration system and possesses inlet and outlet passages having the shape of conduits and a cylindrical housing. The inlet and outlet conduits are formed to extend outward from the housing, and preferably integrated with the housing.

A first valve assembly is provided in a tubular passage of the inlet conduit to control fluid flow. The first valve assembly includes an electromagnetic valve which controls fluid flow in response to an electric signal. A valve body constitutes the first valve assembly in a manner such that a dome-shaped protuberance is formed in the tubular passage of the inlet conduit and an inlet aperture for rendering fluid communication is defined through the dome-shaped protuberance. A solenoid of the first valve assembly can be operated by ON and OFF signals generated by a controller when coupling and decoupling a filter cartridge to and from the manifold, or may be designed to control fluid flow by a separate signaling channel independently of an operation of changing a filter cartridge.

The housing is defined with a flow bore through which water filtered in the filter cartridge can flow and a reservoir in which the filtered water is stored after flowing through the flow bore. Accordingly, the reservoir can appropriately manage a fluid amount variation by storing a predetermined amount of fluid.

A lower part of the housing is provided with first and second fitting mechanisms which in turn are provided with second and third valve assemblies, respectively. A fitting portion of the first fitting mechanism is fitted into an outer flange of the filter cartridge having a double-staged flange structure, and a fitting portion of the second fitting mechanism is fitted into an inner flange of the filter cartridge. At this time, due to the fact that a valve stem of the second valve assembly of the first fitting mechanism is positioned on an upper end surface of the inner flange of the filter cartridge, a valve member is pushed upward to open a flow path. In this way, a fluid flow channel is defined so that it can allow fluid to flow through the inlet conduit into the filter cartridge.

Meanwhile, the second fitting mechanism is moved upward and downward when it is fitted into and removed from the filter cartridge. When being fitted into the filter cartridge, the second fitting mechanism is inserted into a bore which is defined in the first fitting mechanism, so that fluid filtered while passing through a filtering substance disposed in the filter cartridge can be introduced into a reservoir defined in the housing through a flow path defined in the second fitting mechanism.

If the filter cartridge is decoupled from the manifold, the valve member of the second valve assembly of the first fitting mechanism is separated from the upper end surface of the inner flange of the filter cartridge, and returns to its original position in which it closes the flow path to shut off fluid flow into the filter cartridge. Also, as the second fitting mechanism is removed from the inner flange of the filter cartridge, it is moved by a predetermined distance out of the bore defined in the first fitting mechanism, whereby the flow path extending between the filter cartridge and the reservoir of the housing is blocked. On the other hand, due to the fact that the second valve assembly of the first fitting mechanism opens a flow path which directly connects the inlet conduit to the reservoir of the housing while not passing through the filter cartridge, even when the filter cartridge is decoupled from the manifold, fluid can be continuously introduced through the inlet conduit into the reservoir of the housing.

One end of the outlet conduit is provided with a port or chamber. A fourth valve assembly is provided to the chamber, and at this time, the outlet conduit serves as a valve body. The fourth valve assembly includes an electromagnetic valve, and a sealing block is disposed in the chamber. The sealing block generally has a drum-shaped configuration, and an annular recess is defined on a circumferential outer surface of the sealing block. The sealing block is defined with a pair of guide holes which extend in a longitudinal direction and a T-shaped flow path. A flow path switchover member functions to divert fluid flow through the outlet conduit into a first or second outlet conduit part. The flow path switchover member includes a hollow cylindrical body, a pair of bars, a pair of holes and a stopcock. A spring is placed between the flow path switchover member and a bottom surface of the chamber. When a solenoid of the fourth valve assembly is in an OFF state, the spring supports the sealing block and the flow path switchover member against elastic force of another spring which is disposed in the solenoid.

The first and fourth valve assemblies are controlled by the controller in a manner such that they allow fluid flow to be effected in a predetermined direction unless interrupt signals are applied to them. For example, by maintaining the first valve assembly at an ON state and the fourth valve assembly at an OFF state using a signaling channel, a normal flowing direction of fluid discharged from the chamber of the outlet conduit can be maintained as it is. In this regard, it is to be readily understood that fluid flow can be effected in another direction by energizing the solenoid of the fourth valve assembly through application of a separate interrupt signal which is outputted from the controller.

Fluid flow in the normal direction is ensured by the fact that, when the sealing block and the flow path switchover member are assembled with each other and disposed in the chamber, unless the separate interrupt signal is applied to the solenoid of the fourth valve assembly, the flow path switchover member, for example, always closes the T-shaped flow path of the sealing block and opens an outlet aperture which is defined through the valve body to be communicated with the chamber. Due to fluid flow in the normal direction, when the manifold according to the present invention is used along with an ice making apparatus, it is possible to prevent freezing of water. Further, it is to be noted that the normal fluid flow direction is determined by a relationship between outlet ports and devices using fluid.

Flow control means is provided in the reservoir of the housing or the outlet conduit and includes a flow control unit. The flow control unit is made of a soft material and has a sinking surface, an opposite flat surface and a flow control hole defined through a center portion thereof. In the case that the flow control means is provided in the reservoir of the housing, the flow control unit is located in a depression defined on an inner end surface of the housing, which inner end surface faces the outlet conduit, and is supported by a wheel-shaped retainer. On the other hand, in the case that the flow control means is provided in the outlet conduit, after defining a groove in a tubular passage of the outlet conduit, the flow control unit is fitted into the groove.

As a consequence, when fluid is discharged from the reservoir toward the outlet conduit, the fluid flows through the flow control hole of the flow control unit. At this time, because a fluid pressure is applied to the flow control unit, the sinking surface and the opposite flat surface are displaced in a manner such that they are reversed in their surface contours. Due to the displacement, a diameter of one end of the flow control hole, which one end faces the outlet conduit, is slightly increased, and a diameter of the other end of the flow control hole, which other end is farthest from the outlet conduit, is slightly decreased, whereby fluid flow control can be executed in a precise manner.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a manifold according to the present invention, a filter cartridge coupled to the manifold, and a structure for attaching the manifold to an electric appliance;

FIG. 2 is a side view illustrating an in-use status of the manifold according to the present invention, with the filter cartridge coupled to the manifold which is attached to the electric appliance;

FIG. 3 is a cross-sectional view taken along the line A-A of FIG. 2;

FIG. 4 is a cross-sectional view taken along the line B-B of FIG. 3;

FIG. 5 is a cross-sectional view taken along the line C-C of FIG. 3;

FIGS. 6A and 6B are cross-sectional views illustrating states wherein fluid flow through fluid supply lines is allowed and shut off when a filter cartridge is coupled to and decoupled from the manifold according to the present invention, respectively;

FIGS. 7A through 7C show a fourth valve assembly for controlling fluid discharge and a chamber defined in an outlet conduit, wherein FIGS. 7A and 7B are cross-sectional views respectively illustrating states in which fluid flows into first and second branched outlet conduit parts and FIG. 7C is an exploded perspective view illustrating a valve seat and a flow path switchover member;

FIG. 8 is a partial enlarged cross-sectional view illustrating flow control means provided in a branched outlet conduit part; and

FIGS. 9A and 9B are cross-sectional views illustrating a structure for connecting pipes at each joint region of the manifold according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

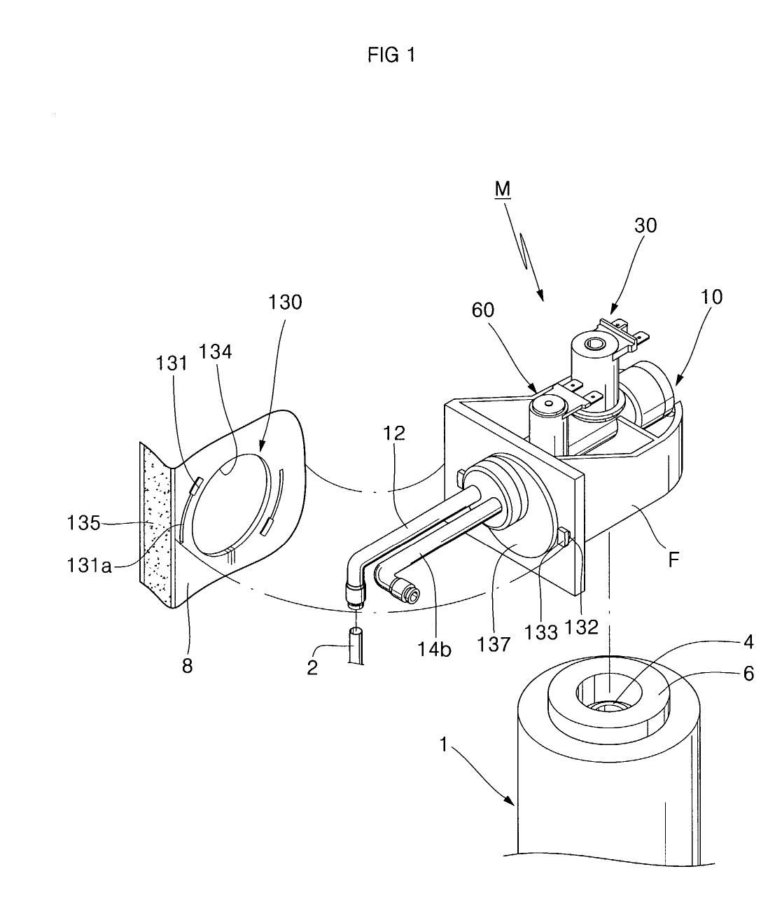

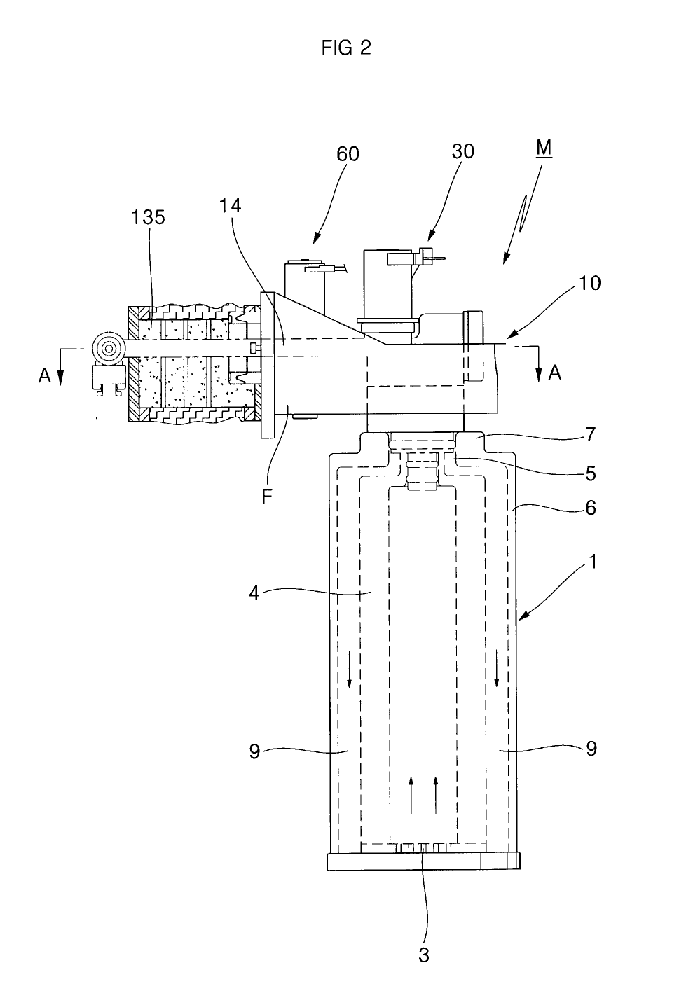

Referring to FIGS. 1 and 2, a manifold M according to the present invention includes a cylindrical housing 10, an inlet conduit 12, and an outlet conduit 14. The inlet conduit 12 is connected to a water supply source by a water supply pipe 2 such as waterworks. If water is supplied through the inlet conduit 12, the water flows through a flow path which defines a flow channel between the inlet conduit 12 and a filter cartridge 1, as will be described later in detail. Then, as shown in FIG. 2 by arrows, the water flows through a flow space 9 which is defined between inner and outer cylindrical canisters 4 and 6 of the filter cartridge 1 serving as a fluid treatment device, and, after flowing through a plurality of holes 3 defined adjacent to a bottom of the filter cartridge 1, passes through a filtering substance (not shown) which is disposed in the inner cylindrical canister 4. Thereafter, the fluid is introduced into the housing 10 through another flow path which defines another flow channel between the filter cartridge 1 and the housing 10 of the manifold M, as will be described later in detail, and thereupon, discharged out of the housing 10 through the outlet conduit 14.

First and fourth valve assemblies 30 and 60 are installed in the inlet and outlet conduits 12 and 14, respectively, to control fluid flow through the inlet and outlet conduits 12 and 14. The inlet conduit 12 of the manifold M is connected with the water supply pipe 2 by a pipe jointing assembly 120, as will be described later in detail.

The manifold M according to the present invention is used in a state wherein it is attached to a wall 8 of an appliance such as a refrigerator. The manifold M can be easily attached to and detached from the wall 8 by virtue of a fixing unit 130. The fixing unit 130 includes a pair of heads 133 which are provided on a frame F of the manifold M, a pair of shank portions 132 for respectively supporting the heads 133, and a circular plate 137. The wall 8 of the appliance is defined with a pair of curved slits 131a which are opposite to each other and have enlarged slit portions 131, and an opening 134 for receiving the circular plate 137. The pair of slits 131a generally define a circular figure.

When fixing the manifold M to the appliance, by fitting the heads 133 into the enlarged slit portions 131 and then rotating the manifold M in a counterclockwise direction, the manifold M is attached to the wall 8 by the medium of the shank portions 132 inserted into the curved slits 131a. At this time, as the circular plate 137 is fitted into the opening 134, a fixed state of the manifold M can be stably maintained. An adiabatic material 135 is interposed between the inlet conduit 12 and the outlet conduit 14.

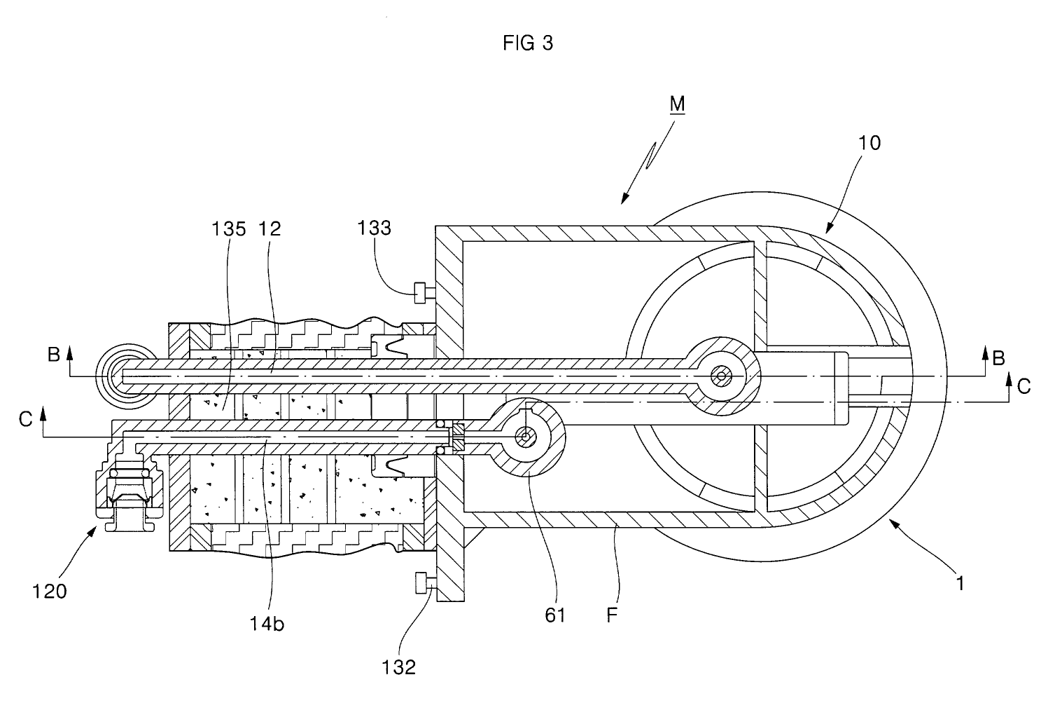

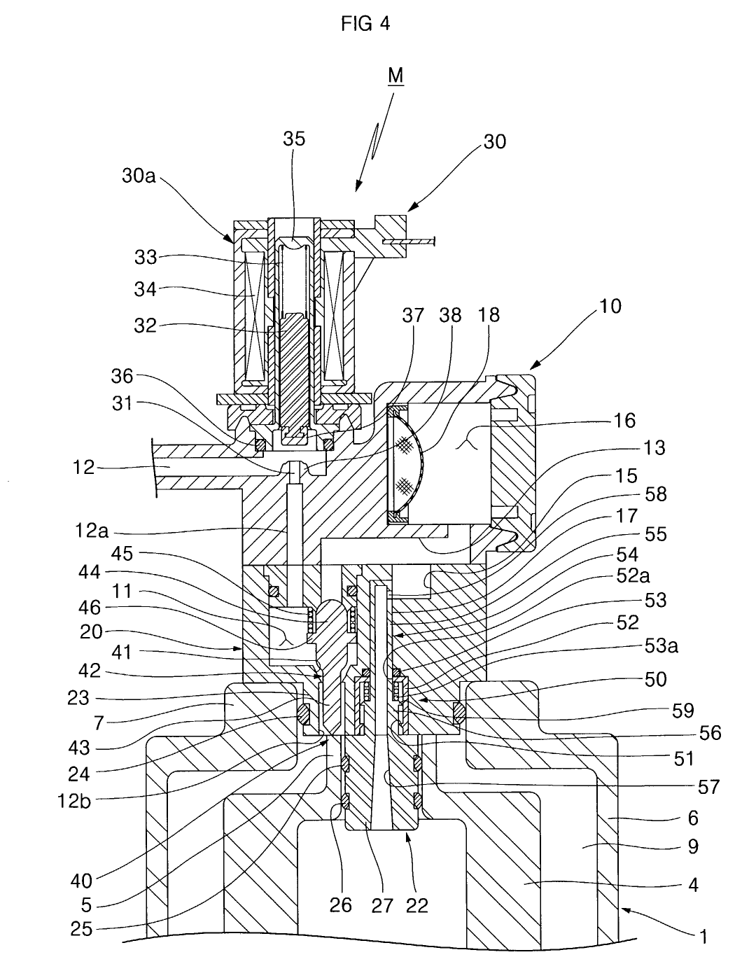

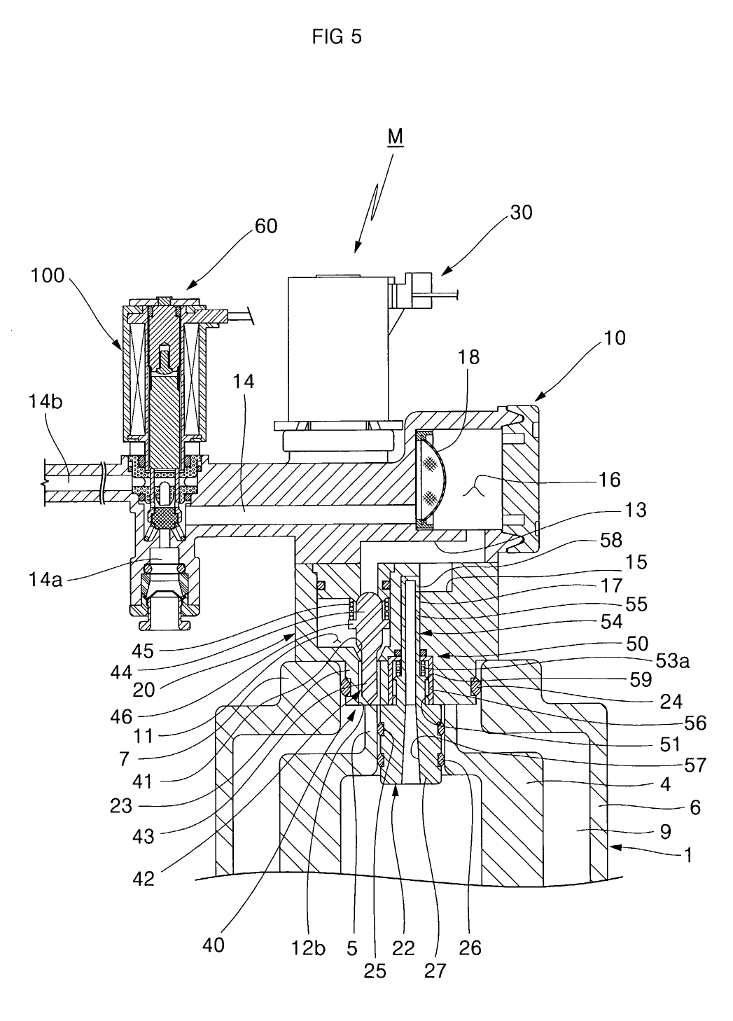

Referring to FIGS. 3 through 6, it is to be readily understood that the manifold M has the housing 10 and the inlet conduit 12 which is fixed to a side wall of the housing 10 and is formed to extend by a substantial length. The inlet conduit 12 has an inlet passage 12a which is substantially perpendicularly downwardly bent in relation to an entrance of the inlet conduit 12. A first valve assembly 30 is provided at a point where the inlet conduit 12 and the inlet passage 12a meet each other. The first valve assembly 30 includes an electromagnetic valve. A solenoid 30a has a casing 35, a movable member 32 provided in the casing 35, and a spring 33. A coil 34 functions to create a magnetic field in response to an electric signal and thereby move the movable member 32. An O-ring 36 is provided to prevent water leakage. The movable member 32 is provided with a valve head 37, and a valve seat 38 is defined with a communication hole 31. In the first valve assembly 30, a portion of the inlet conduit 12 serves as a valve body.

A lower part of the housing 10 of the manifold M is provided with a first fitting mechanism 20. The first fitting mechanism 20 has a first fitting portion 23 which is fitted into the filter cartridge 1, and a second valve assembly 40 for controlling fluid flow from the inlet conduit 12 through the inlet passage 12a into the filter cartridge 1 upon coupling and decoupling the filter cartridge 1 to and from the manifold M. The inlet passage 12a is communicated with a cavity 11 which is defined beneath the inlet passage 12a. The cavity 11 functions to temporarily store fluid and afford a space for installing the second valve assembly 40.

The first fitting portion 23 of the first fitting mechanism 20 is defined with an inlet aperture 12b. The inlet conduit 12 can be sequentially communicated with the communication hole 31, the inlet passage 12a, the cavity 11 and finally the inlet aperture 12b, and in this way, a fluid flow channel extending from the inlet conduit 12 to the filter cartridge 1 is primarily defined. Upon coupling the filter cartridge 1 to the manifold M, the first fitting portion 23 is fitted into a flange 7 of the outer cylindrical canister 6 of the filter cartridge 1.

A reservoir 16 is defined in the housing 10 of the manifold M. The reservoir 16 stores a predetermined amount of fluid to be capable of accommodating an abrupt fluid amount variation. A filter 18 is provided at one end of the reservoir 16 through which fluid is discharged into the outlet conduit 14. A first flow path 13 is defined in the housing 10 for allowing fluid communication between the reservoir 16 and the cavity 11. Therefore, another fluid flow channel extending from the inlet conduit 12 through the communication hole 31, the inlet passage 12a, the cavity 11 and the first flow path 13 to the reservoir 16 is secondarily defined.

The second valve assembly 40 of the first fitting mechanism 20 has a valve member 42. A valve stem 43 of the valve member 42 is located in the inlet aperture 12b and has a diameter which is less than that of the inlet aperture 12b, to allow the fluid flow channel to be defined in the inlet aperture 12b. A projection 46 is provided to a valve head 44 of the valve member 42, and a spring 45 is arranged between the projection 46 and an adjacent wall defining the first flow path 13. A tapered surface 41 is formed in the course of the inlet aperture 12b to serve as a valve seat on which the valve head 44 can be seated upon downward movement of the valve member 42.

In addition to the first fitting mechanism 20, the lower part of the housing 10 of the manifold M is provided with a second fitting mechanism 22. The second fitting mechanism 22 is installed in a center bore 17 which is defined in the first fitting mechanism 20. The second fitting mechanism 22 has a second fitting portion 27 which is fitted into a flange 5 of the inner cylindrical canister 4 of the filter cartridge 1 upon coupling the filter cartridge 1 to the manifold M, and a third valve assembly 50 for controlling flow of filtered water from the filter cartridge 1 to the reservoir 16 of the housing 10 upon coupling and decoupling the filter cartridge 1 to and from the manifold M.

In order to install the third valve assembly 50, a cylinder 52 is mounted in the center bore 17 of the first fitting mechanism 20. The cylinder 52 has a cylinder bore 52a and a stopper projection 51 which is projectedly formed on a circumferential inner surface of the cylinder 52. The third valve assembly 50 includes a valve member 54. The valve member 54 is integrally formed with the second fitting portion 27 which is fitted into the inner flange 5 of the filter cartridge 1 upon coupling the filter cartridge 1 to the manifold M. A valve head 56 of the valve member 54 integrally extends upward from the second fitting portion 27, and a guide projection 59 is formed on a circumferential outer surface of an upper end of the valve head 56. A valve stem 55 is slidably inserted into the center bore 17 of the first fitting mechanism 20 after passing thorough the cylinder bore 52a. Adjacent to an upper end of the valve stem 55, an exit aperture 58 is defined through a side of the valve stem 55. A spring 53a is provided between the valve head 58 and an inner surface of an upper wall of the cylinder 52, which upper wall defines the cylinder bore 52a. An O-ring 53 is provided to prevent water leakage.

A third flow path 57 is defined through the second fitting mechanism 27 and the valve member 54 to be communicated with the exit aperture 58. Further, a second flow path 15 is defined in an upper end surface of the first fitting mechanism 20 to be communicated with the exit aperture 58 of the valve stem 55. The second flow path 15 functions to communicate the third flow path 57 and the exit aperture 58 with the first flow path 13 to thereby introduce fluid discharged from the filter cartridge 1 to the reservoir 16 of the housing 10. A plurality of O-rings 24, 25 and 26 serve as sealing means for preventing water leakage upon coupling the filter cartridge 1 to the manifold M.

The filter cartridge 1 which is coupled to the manifold M has the inner and outer cylindrical canisters 4 and 6 which in turn have inner and outer flanges 5 and 7, respectively. Upon coupling the filter cartridge 1 to the manifold M, the first fitting portion 23 of the first fitting mechanism 20 is press-fitted into the outer flange 7 of the filter cartridge 1, and the second fitting portion 27 of the second fitting mechanism 22 is press-fitted into the inner flange 5 of the filter cartridge 1. Therefore, in correspondence to a double-staged fitting mechanism structure of the manifold M, the filter cartridge 1 is designed to have a double-staged flange structure.

Fluid introduced into the reservoir 16 of the housing 10 of the manifold M is filtered by a filter 18 and then discharged into the outlet conduit 14. As will be described later in detail, a chamber 61 is defined at a distal end of the outlet conduit 14, and a fourth valve assembly 60 is provided in the chamber 61 to allow fluid flow to be divided into several directions.

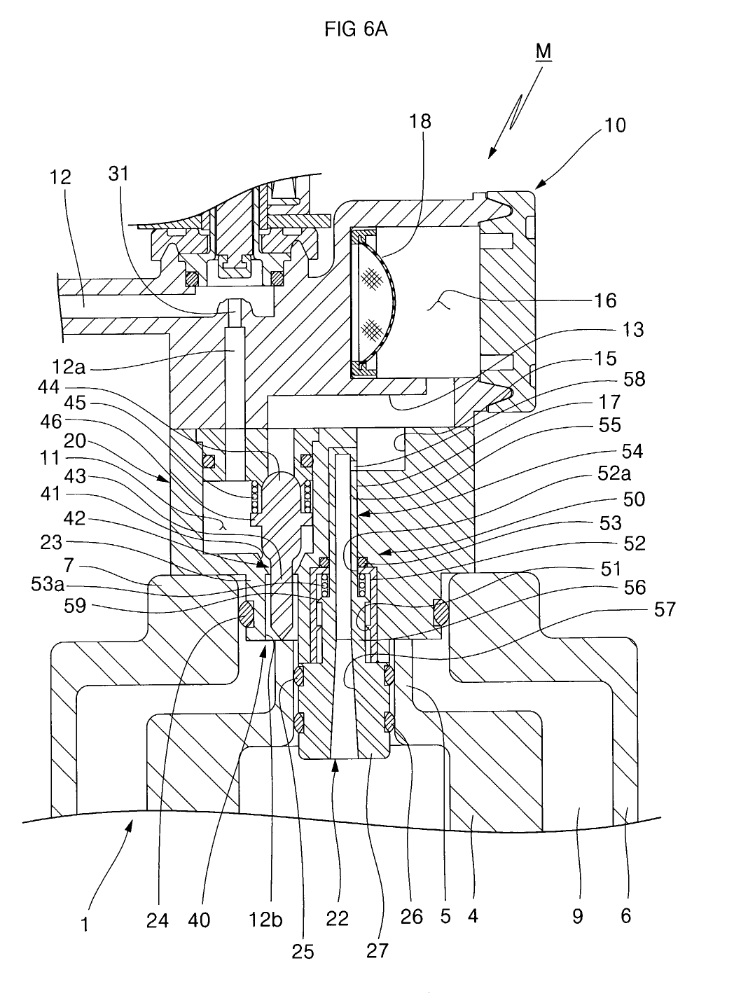

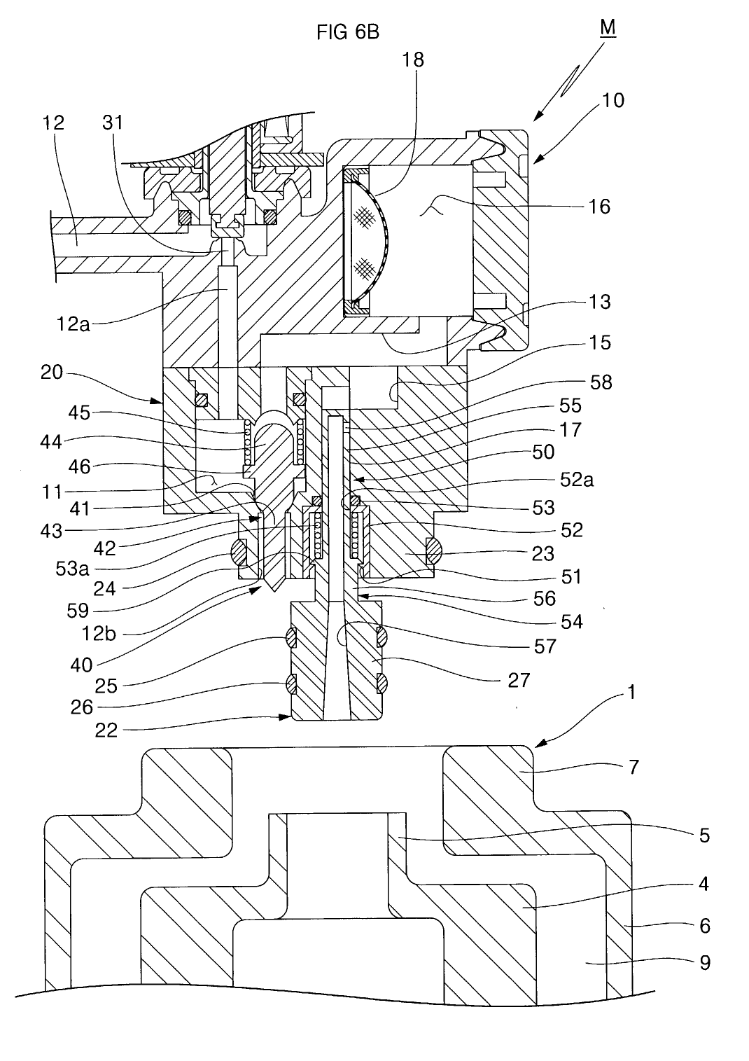

Hereafter, operations of the first through third valve assemblies 30, 40 and 50 upon coupling and decoupling the filter cartridge 1 to and from the manifold M and fluid flow through the fluid supply lines will be described. When the filter cartridge 1 is coupled to the manifold M, the first fitting portion 23 of the first fitting mechanism 20 of the manifold M is fitted into the outer flange 7 of the filter cartridge 1, and the second fitting portion 27 of the second fitting mechanism 22 is fitted into the inner flange 5. When it is necessary to allow fluid flow from the inlet conduit 12 into the filter cartridge 1, an electric signal is applied to the solenoid 30a to open the communication hole 31 of the first valve assembly 30. For example, a controller (not shown) may be configured to energize the solenoid 30a upon coupling the filter cartridge 1 to the manifold M (see FIG. 6A) and deenergize the solenoid 30a upon decoupling the filter cartridge 1 from the manifold M (see FIG. 6B). If an ON signal is applied to the coil 34 to energize the solenoid 30a, as shown in FIG. 6A, as electromagnetic force is applied to the movable member 32, the movable member 32 is moved upward against elastic force of the spring 33 and opens the communication hole 31. Accordingly, fluid flows from the inlet conduit 12 through the communication hole 31 and the inlet passage 12a into the cavity 11.

When the filter cartridge 1 is coupled to the manifold M, a free end of the valve stem 43 of the valve member 42 of the second valve assembly 40 is brought into contact with an upper end surface of the inner flange 5 of the filter cartridge 1. By pushing force of the inner flange 5, the valve member 42 is moved upward against elastic force of the spring 45. As the valve member 42 is moved upward, the valve head 44 is separated from the tapered surface 41 and at the same time closes the first flow path 13, whereby fluid stored in the cavity 11 flows through the fluid flow channel defined between the valve stem 43 and the inlet aperture 12b into the flow space 9 defined in the filter cartridge 1.

Also, when the filter cartridge 1 is coupled to the manifold M, as the second fitting portion 27 of the second fitting mechanism 22 is fitted into the inner flange 5, the second fitting mechanism 22 is slidingly moved upward in the center bore 17 of the first fitting mechanism 20 and in the cylinder 52, against elastic force of the spring 53a. That is to say, the valve head 56 of the valve member 54 of the second fitting mechanism 22 is slidingly moved upward in the cylinder 52, and the valve stem 55 is slidingly moved upward through the cylinder bore 52a in the center bore 17. At this time, the exit aperture 58 of the valve stem 55 is fluid-communicated with the second flow path 15.

Hence, fluid filtered while passing through the filtering substance disposed in the filter cartridge 1 is discharged through the third flow path 57 and the exit aperture 58 into the second flow path 15 and then introduced through the first flow path 13 into the reservoir 16 of the housing 10. Thereafter, fluid is discharged from the reservoir 16 through the filter 18 into the outlet conduit 14 to be directed to a desired device, for example, a cooling device of a refrigerator.

On the other hand, when the filter cartridge 1 is decoupled from the manifold M, as an OFF signal generated by the controller is applied to the solenoid 30a of the first valve assembly 30, as shown in FIG. 6B, the movable member 32 is moved downward by elastic force of the spring 33, and the valve head 37 closes the communication hole 31. Also, as the valve stem 43 of the valve member 42 of the second valve assembly 40 is separated from the upper end surface of the inner flange 5 of the filter cartridge 1, the valve member 42 is moved downward by elastic force of the spring 45 and the valve head 44 closes the inlet aperture 12b, whereby the first flow path 13 is opened to allow fluid communication between the cavity 11 and the reservoir 16. In this way, water leakage is primarily prevented. Thus, fluid flow from the inlet conduit 12 through the inlet aperture 12b into the filter cartridge 1 is shut off, and fluid flow from the inlet conduit 12 through the first flow path 13 into the reservoir 16 can be allowed by controlling the first valve assembly 30.

In other words, if an interrupt signal for actuating the first valve assembly 30 is applied by manipulating a switch of the controller, the communication hole 31 is opened. As a consequence, in spite of decoupling the filter cartridge 1 from the manifold M, fluid flows from the inlet conduit 12 through the communication hole 31, the inlet passage 12a and the cavity 11 into the first flow path 13. Then, after being introduced into the reservoir 16, fluid is discharged into the outlet conduit 14. At this time, fluid which does not pass through the filter cartridge 1 is filtered by the filter 18 arranged in the reservoir 16.

Also, when the filter cartridge 1 is decoupled from the manifold M, the second fitting mechanism 22 is moved downward from the center bore 17 by elastic force of the spring 53a. The downward movement of the second fitting mechanism 22 is limited by engagement of the guide projection 59 of the valve member 54 with the stopper projection 51 of the cylinder 52. At this time, fluid flow between the exit aperture 58 of the valve stem 55 of the valve member 54 and the second flow path 15 is shut off, and therefore, water leakage from the first flow path 13 through the second path 15 and the exit aperture 58 is prevented.

In succession, referring to FIGS. 3 through 7, fluid flows from the reservoir 16 into the outlet conduit 14 which extends substantially parallel to the inlet conduit 12, to then be finally supplied to a destination device, for example, an ice making section or a cooling section of a refrigerator. A person skilled in the art will readily recognize that the number of outlet conduits may vary depending upon a use of the manifold. Also, it can be envisaged that the outlet conduit 14 extends in a reverse direction to the inlet conduit 12. As described above, the chamber 61 is defined at the distal end of the outlet conduit 14, and the fourth valve assembly 60 is provided in the chamber 61.

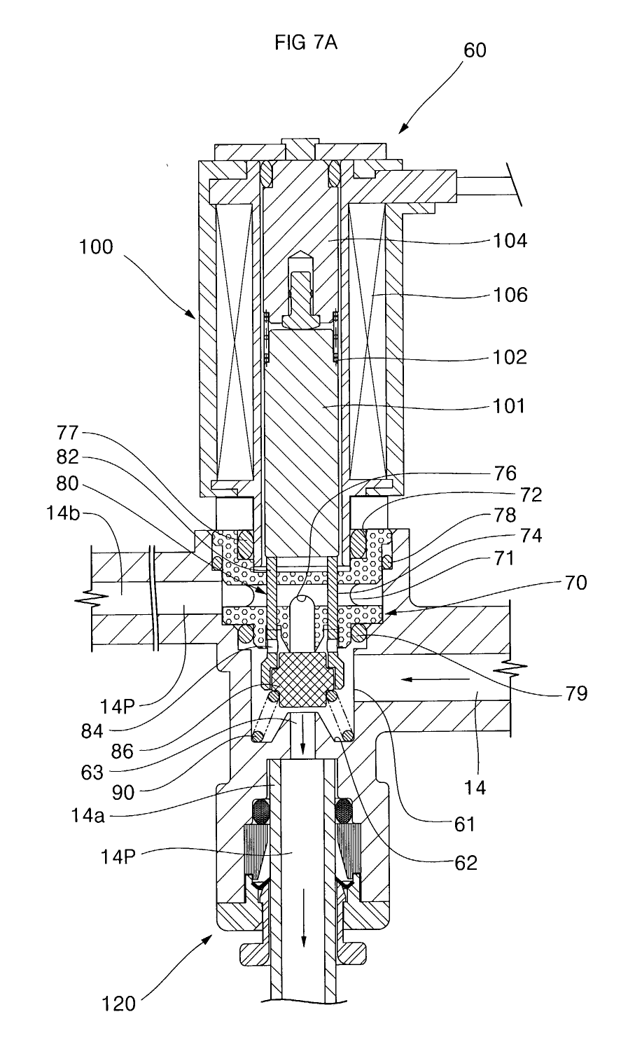

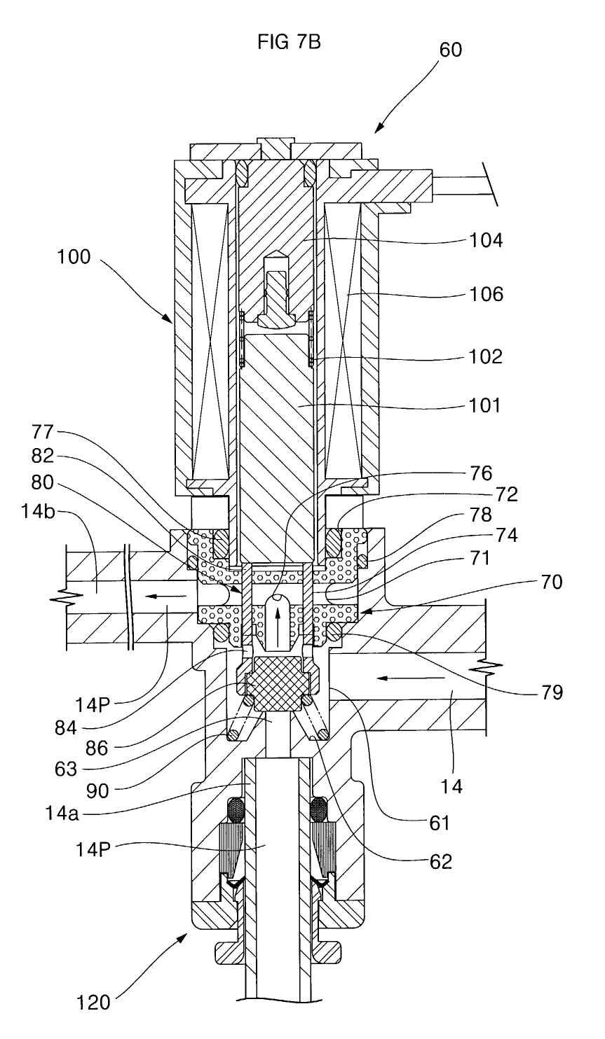

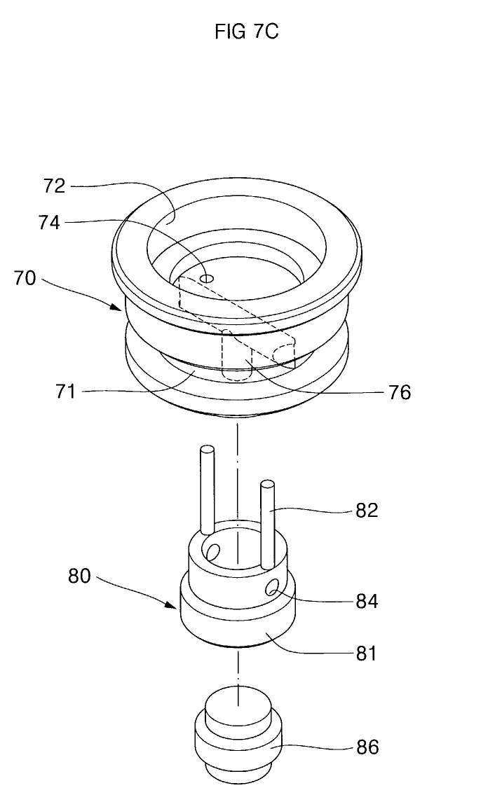

Describing a relationship between the chamber 61 defined in the outlet conduit 14 and the fourth valve assembly 60 disposed in the chamber 61 with reference to FIG. 7, the distal end of the outlet conduit 14 which is distant from the housing 10 is divided into first and second outlet conduit parts, and pipe jointing assemblies 120 are provided to joint pipes to the first and second outlet conduit parts, as will be described later in detail. The distal end of the outlet conduit 14 to which the pipe jointing assemblies 120 are provided serves as a valve box or a valve body for the fourth valve assembly 60. A plurality of ports 14P can be provided to the distal end of the outlet conduit 14 to supply fluid in various directions.

The distal end of the outlet conduit 14 serving as the valve body is defined with the chamber 61 which has a plurality of stepped shoulders. The valve device disposed in the chamber 61 performs a function of a multi-port connecting device. A tapered projection 62 is formed on a bottom surface of the chamber 61 to serve as a valve seat, and an outlet aperture 63 is defined through the tapered projection 62.

A sealing block 70 which generally has a drum-shaped configuration is placed in the chamber 61. The sealing block 70 is defined, at a middle portion and on a circumferential outer surface thereof, with an annular recess 71. Also, the sealing block 70 is defined, on an upper surface thereof, with a receiving groove 72. A pair of guide holes 74 which extend in a longitudinal direction are defined through a bottom of the receiving groove 72. A T-shaped flow path 76 is defined in the sealing block 70 below the receiving groove 72 and adjacent to the guide holes 74. O-rings 77, 78 and 79 are provided to prevent water leakage.

The fourth valve assembly 60 includes a flow path switchover member 80. The flow path switchover member 80 has a hollow cylindrical body 81, a pair of bars 82 which extend upward from an upper end of the hollow cylindrical body 81, and a pair of holes 84 which are defined through opposite sides of the hollow cylindrical body 81. When the flow path switchover member 80 is coupled with the sealing block 70, the bars 82 of the flow path switchover member 80 are respectively inserted through the guide holes 74 of the sealing block 70 in a manner such that the bars 82 can be slidingly moved upward and downward in the guide holes 74. In a state wherein the flow path switchover member 80 and the sealing block 70 are coupled with each other, the holes 84 of the flow path switchover member 80 are communicated with the chamber 61.

A stopcock 86 having a cross-shaped sectional configuration is fitted into a lower end of the flow path switchover member 80. A height of the stopcock 86 is determined in a manner such that the stopcock 86 does not block the holes 84 upon being fitted into the flow path switchover member 80. The flow path switchover member 80 into which the stopcock 86 is fitted is supported by a spring 90. Here, elastic force of the spring 90 is set to be larger than that of a spring 102 arranged in a solenoid 100, in a manner such that, when a magnetic field is not created in the solenoid 100, the flow path switchover member 80 is not moved downward by being pressed by a movable member 101.

The fourth valve assembly 60 includes an electromagnetic valve. The solenoid 100, that is, an actuator serving as the electromagnetic valve has the movable member 101, a fixed member 104, and the spring 102 which is interposed between the movable and fixed members 101 and 104. A coil 106 provided to the solenoid 100 creates a magnetic field in response to application of an electric signal to move the movable member 101.

A pair of pipe jointing assemblies 120 are provided in the distal end of the outlet conduit 14 in which the fourth valve assembly 60 is disposed and which is divided into the first and second outlet conduit parts 14a and 14b, as will be descried later in detail. As a consequence, fluid flows from the housing 10 of the manifold M through the outlet conduit 14 and is then discharged into the first or second outlet conduit part 14a or 14b by way of the fourth valve assembly 60.

Describing operations of the manifold M according to the present invention, constructed as mentioned above, with reference to FIGS. 3 through 7, in one example, the second and third valve assemblies 40 and 50 are configured to ensure that fluid communication is allowed and shut off when the filter cartridge 1 is coupled to and decoupled from the manifold M, respectively, and thereby, water leakage is prevented upon changing the filter cartridge. Generation of ON and OFF control signals in association with operations of the first and fourth valve assemblies 30 and 60 can be effected depending upon coupling or decoupling of the filter cartridge 1 to or from the manifold M. Accordingly, it can be contemplated that, when the filter cartridge 1 is coupled to the manifold M, an electric signal is generated by the controller to operate the first and fourth valve assemblies 30 and 60. In this connection, in a preferred embodiment of the present invention, the first and fourth valve assemblies 30 and 60 are configured in a manner such that they are reversely operated to each other by an electric signal generated when the filter cartridge 1 is coupled to the manifold M. That is to say, it can be envisaged that, by an electric signal generated upon coupling the filter cartridge 1 to the manifold M, the solenoid 30a of the first valve assembly 30 is maintained in an ON state and the solenoid 100 of the fourth valve assembly 60 is maintained in an OFF state. By configuring the first and fourth valve assemblies 30 and 60 as described above in a manner such that they are normally reversely operated to each other unless a separate interrupt signal is applied, it is possible to prevent freezing of the ice making apparatus and avoid a water hammer phenomenon, as will be described later in detail.

By an electric signal which is generated upon coupling the filter cartridge 1 to the manifold M, the solenoid 30a of the first valve assembly 30 is switched to the ON state, and thereby, the movable member 32 is moved upward while overcoming elastic force of the spring 33, to open the communication hole 31. As the communication hole 31 is opened, fluid flows from the inlet conduit 12 into the flow space 9 defined in the filter cartridge 1 and is changed in its flow direction at the holes 3. Then, after passing through the filtering substance which is disposed in the inner cylindrical canister 4 of the filter cartridge 1, the fluid is introduced into the reservoir 16 of the housing 10 and is then discharged into the outlet conduit 14. As for operations of the first through third valve assemblies 30, 40 and 50 depending upon coupling and decoupling of the filter cartridge 1 to and from the manifold M and provision of the fluid flow channels thereby, since they are described in detail, further explanation thereof shall be omitted herein, and instead, interrelated operations of the first and fourth valve assemblies 30 and 60 will be described hereinbelow.

When the solenoid 30a of the first valve assembly 30 is in the ON state, as can be readily seen from FIG. 7A, since the solenoid 100 of the fourth valve assembly 60 is maintained in the OFF state, the movable member 101 is held stopped. At this time, due to the fact that the elastic force of the spring 90 supporting the flow path switchover member 80 is larger than that of the spring 102 which is arranged between the movable and fixed members 101 and 104 in the solenoid 100, the movable member 101 cannot downwardly move the bars 82 of the flow path switchover member 80. Accordingly, an upper surface of the stopcock 86 of the flow path switchover member 80 closes an entrance to the T-shaped flow path 76 of the sealing block 70 and opens the outlet aperture 63 of the chamber 61. Therefore, fluid is discharged through the outlet conduit 14 into the first branched outlet conduit part 14a.

With the filter cartridge 1 coupled to the manifold M, while fluid is continuously supplied, if it is required to divert fluid flow from the first branched outlet conduit part 14a into the second branched outlet conduit part 14b, as a separate signal is applied from the controller, the solenoid 100 of the fourth valve assembly 60 is converted into the ON state and current flows through the coil 106, whereby the movable member 101 is moved downward. Namely, as can be readily seen from FIG. 7B, the movable member 101 is moved downward by electromagnetic force. By this fact, as the bars 82 of the flow path switchover member 80 are pressed, the flow path switchover member 80 is also moved downward against elastic force of the spring 90. Hence, the stopcock 86 of the flow path switchover member 80 closes the outlet aperture 63 of the chamber 61.

If the outlet aperture 63 of the chamber 61 is closed, fluid flowing into the chamber 61 through the outlet conduit 14 is discharged through the holes 84 of the flow path switchover member 80 and the T-shaped flow path 76 of the sealing block 70 into the second branched outlet conduit part 14b.

While fluid flows into the second branched outlet conduit part 14b, if the application of the electric signal from the controller is interrupted or the filter cartridge 1 is decoupled from the manifold M, the solenoid 100 of the fourth valve assembly 60 is switched to the OFF state. Thereby, as shown in FIG. 7A, the flow path switchover member 80 is moved upward by elastic force of the spring 90 to close the T-shaped flow path 76 of the sealing block 70, whereby fluid is discharged into the first branched outlet conduit part 14a.

In the manifold M according to the present invention, by causing the first and fourth valve assemblies 30 and 60 to be reversely operated to each other and thereby controlling fluid flow through the fluid supply lines, in the case of using the present manifold M along with the ice making apparatus, it is possible to prevent the conduits from being frozen. That is to say, describing the case that a refrigerator is used as the appliance, the refrigerator needs water to be used for a cooling section and an ice making section. In this regard, in the manifold M according to the present invention, the first outlet conduit part 14a is connected to the cooling section, and the second outlet conduit part 14b is connected to the ice making section. Thus, if the filter cartridge 1 is coupled to the manifold M, fluid flows from the inlet conduit 12 into the filter cartridge 1 and is then introduced into the reservoir 16 of the housing 10. Then, the fluid flows through the outlet conduit 14 and enters the chamber 61. At this time, since the outlet aperture 63 is maintained in an opened state, the fluid is discharged through the first branched outlet conduit part 14a into the cooling section. If the solenoid 100 of the fourth valve assembly 60 is converted into the ON state by application of a separate electric signal from the controller, the flow path switchover member 80 closes the outlet aperture 63, and fluid is discharged into the second branched outlet conduit part 14b. If the signal application from the controller is interrupted or the filter cartridge 1 is decoupled from the manifold M, the solenoid 100 of the fourth valve assembly 60 is switched to the OFF state, and fluid flow into the second branched outlet conduit part 14b is shut off.

As described above, since fluid flow into the second branched outlet conduit part 14b is permitted only upon an active request by signal application, when an amount of fluid flowing through the second branched outlet conduit part 14b into the ice making section is decreased due to a pressure decrease by change in fluid amount as it occurs where the filter cartridge 1 is decoupled from the manifold M, it is possible to prevent the second branched outlet conduit part 14b and surrounding arrangements from being frozen.

While it was described that the first and fourth valve assemblies 30 and 60 are configured to be reversely operated to each other, it is to be noted that this description is given only for illustrative purposes. Therefore, in the case that fluid is to be normally discharged through the second branched outlet conduit part 14b, the first and fourth valve assemblies 30 and 60 are configured to be simultaneously operated with each other so that they are commonly maintained in the ON state or OFF state.

By configuring the first and fourth valve assemblies 30 and 60 in a manner such that they are normally reversely operated to each other to control fluid flow through the fluid supply lines unless a separate interrupt signal is applied, it is possible to avoid a water hammer phenomenon. When the first valve assembly 30 is energized or deenergized, a corresponding operation for the fourth valve assembly 60 is delayed by a predetermined time interval, whereby fluid shock due to abrupt inflow or outflow from the filter cartridge 1 into or from the conduits 12, 14, 14a and 14b of the manifold M is avoided.

As described above, in the manifold M according to the present invention, the flow parts or passages for inflow and outflow of fluid are provided in the shape of conduits. For this reason, it is possible to secure a space such as the reservoir 16 in the housing 10 of the manifold M, and flow control means 110 can be provided to the secured space, that is, reservoir 16, as will be described later in detail. Further, because it is possible to install in the conduits 12, 14, 14a and 14b the valve assemblies or means capable of controlling inflow and outflow of fluid, not only can valve assembly installing operations be easily executed, but also necessary measures can be taken even in the case of breakdown of the valve assemblies.

Moreover, the port or chamber 61 can be formed in each course of the inlet and outlet conduits 12, 14, 14a and 14b. Using this chamber 61, a valve assembly can be installed, and various mechanisms capable of controlling fluid flow can be provided. Therefore, by forming the chamber 61 in each of the conduits 12, 14, 14a and 14b and installing the valve assembly in the chamber 61, the pipe jointing means or assemblies 120 can be utilized to easily joint and disjoint conduits with and from one another.

Referring to FIGS. 3 through 8, specifically, 8, the flow control means 110 is selectively provided in the reservoir 16 of the housing 10, the outlet conduit 14, the first branched outlet conduit part 14a or the second branched outlet conduit part 14b. In this preferred embodiment of the present invention, the flow control means 110 is provided to the second branched outlet conduit part 14b. The flow control means 110 has a disc-shaped flow control unit 111. The flow control unit 111 is made of a material having a predetermined flexibility in a manner such that the flow control unit 111 can be displaced by a pressure change of fluid flowing through the second branched outlet conduit part 14b.

The flow control unit 111 has a gradually curved and sinking surface 112 which is distant from the fourth valve assembly 60, and a flat surface which is opposite to the gradually curved and sinking surface 112. A flow control hole 114 is defined through a center portion of the flow control unit 111.

An annular groove 115 is defined on a circumferential inner surface of the second branched outlet conduit part 14b, and the flow control unit 111 is fitted into the annular groove 115.

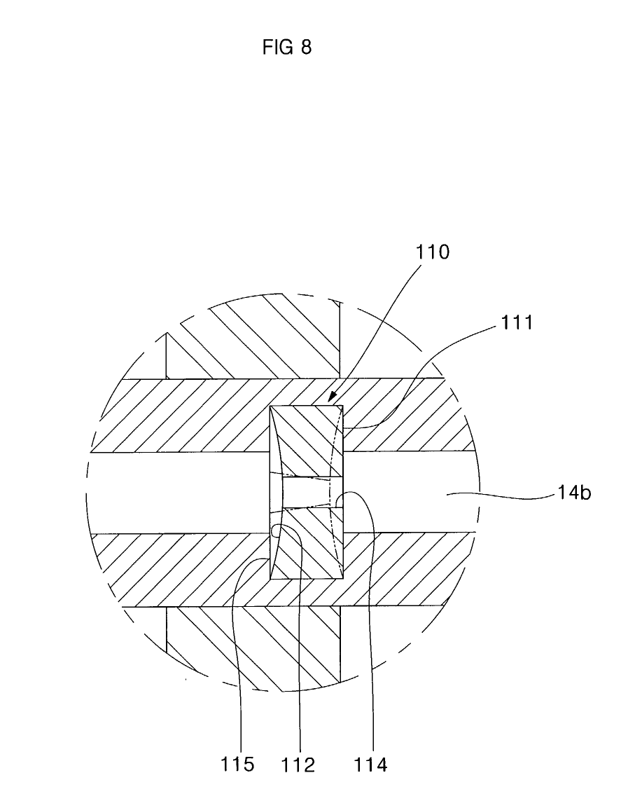

When fluid does not flow from the reservoir 16 of the housing 10 through the fourth valve assembly 60 into the second branched outlet conduit part 14b, the flow control unit 111 is maintained in an initially installed state. That is to say, the gradually curved and sinking surface 112 which is distant from the fourth valve assembly 60 is maintained in a curved and sinking state, and the opposite flat surface is maintained in a flattened state. On the other hand, if fluid starts to flow from the reservoir 16 of the housing 10 into the second branched outlet conduit part 14b, as a fluid pressure is applied to the flat surface of the flow control unit 111 while fluid flows through the flow control hole 114, the gradually curved and sinking surface 112 of the flow control unit 111 made of a flexible material is moved forward to be flattened and then comes into surface contact with a front surface (a left surface in FIG. 8) of the annular groove 115. On the other hand, as the flat surface opposite to the sinking surface 112 is gradually depressed, the flow control unit 111 experiences displacement.

The flow control hole 114 is influenced by the displacement in which the gradually curved and sinking surface 112 and opposite flat surface of the flow control unit 111 are reversed in their surface contours. Hence, by the fact that the sinking surface 112 is transformed from a curved surface to a flat surface by fluid flow through the flow control hole 114, a diameter of one end of the flow control hole 114, which one end is distant from the fourth valve assembly 60, is slightly increased. On the contrary, a diameter of the other end of the flow control hole 114, which other end faces the fourth valve assembly 60, is slightly decreased. As a result, the flow control hole 114 generally has a funnel-shaped configuration. In the case that fluid does not flow through water supply lines due to decoupling of the filter cartridge 1 from the manifold M, the flow control unit 111 is returned to its original state. In this way, fluid flow control can be executed by the flow control means 110 in the second branched outlet conduit part 14b in correspondence to fluid flow and fluid flow interruption.

Of course, a degree to which a diameter of the flow control hole 114 of the flow control unit 111 is changed may be varied depending upon a size of an appliance employing the manifold M. In other words, in the case that a diameter of the outlet conduits 14, 14a and 14b of the manifold M is large, a size of the flow control unit 111 and a diameter of the flow control hole 114 are increased, and vice versa. Accordingly, the flow control means 110 according to the present invention is able to control fluid flow in conformity with a given situation.

In the manifold M according to the present invention, since inlet and outlet passages are defined in the shape of conduits, at any position, the conduits 12, 14, 14a and 14b can be easily branched to extend toward desired places and can be easily jointed with other fluid supply pipes. That is to say, the pipe jointing assembly 120 capable of being easily jointed and disjointed can be used to connect the inlet conduit 12 with the water supply pipe 2 as shown in FIG. 1 and to branch and joint the outlet conduits 14, 14a and 14b with other fluid supply pipes as shown in FIGS. 3 through 7.

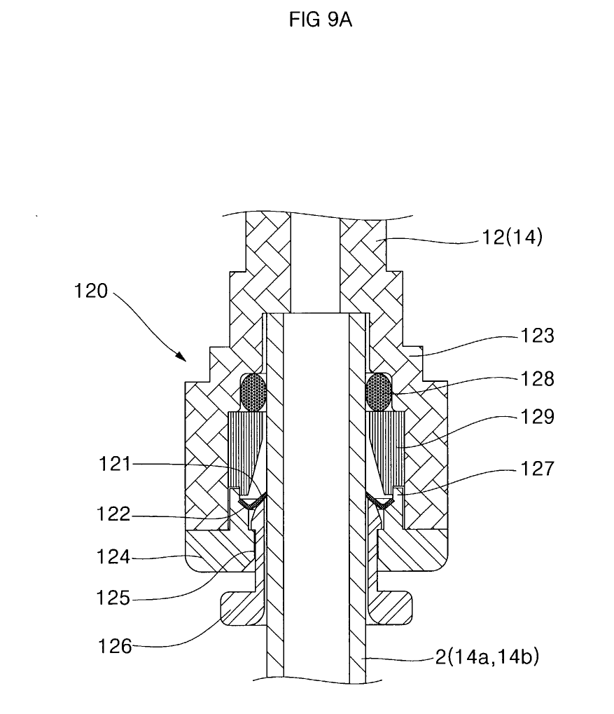

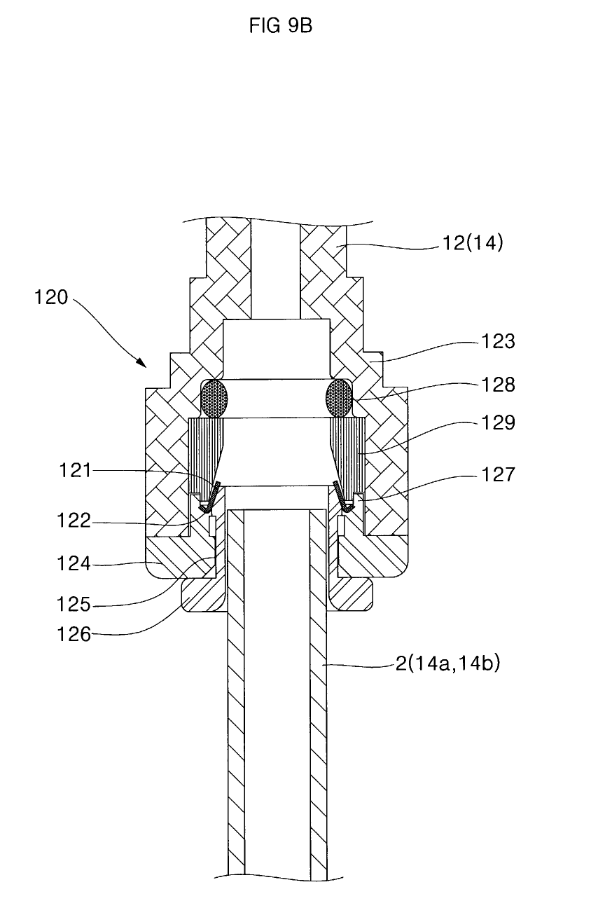

FIG. 9A illustrates a state wherein two pipes are connected with each other, and FIG. 9B illustrates another state wherein two pipes are disconnected from each other. Describing, for example, the case that the inlet conduit 12 and the water supply pipe 2 are connected with each other, a coupling end portion 123 of the inlet conduit 12 has a plurality of stepped surfaces on which various component elements are disposed. The pipe jointing assembly 120 includes a pipe fastening member 122. The pipe fastening member 122 has an annular frame portion and a plurality of elastic supporting fragments 121 integrally extending from the annular frame portion. Also, the pipe jointing assembly 120 is provided with a cylindrical fixing cap 124. The cylindrical fixing cap 124 has a head and a shoulder 127 for holding the pipe fastening member 122. The fixing cap 124 is defined with a center hole 125 through which the inlet conduit 12 can be inserted. The pipe jointing assembly 120 further includes an unlocking member 126 for allowing the inlet conduit 12 and the water supply pipe 2 to be decoupled from each other, and a holder 129 which has an inclined surface for keeping the pipe fastening member 122 from being released upon decoupling the inlet conduit 12 and the water supply pipe 2 from each other. Further, an O-ring 128 is provided to prevent water leakage.

When the inlet conduit 12 and the water supply pipe 2 are connected with each other, as shown in FIG. 9A, by pushing the water supply pipe 2 into the inlet conduit 12, the water supply pipe 2 is inserted into the inlet conduit 12 while overcoming force of the elastic supporting fragments 121 of the pipe fastening member 122 until a free end of the water supply pipe 2 is brought into contact with an innermost stepped surface which is formed in the coupling end portion 123 of the inlet conduit 12. Then, as the elastic supporting fragments 121 of the pipe fastening member 122 radially apply force to the water supply pipe 2, the water supply pipe 2 is reliably held coupled to the inlet conduit 12.

When the inlet conduit 12 and the water supply pipe 2 are disconnected from each other, as shown in FIG. 9B, by pushing the unlocking member 126 into the coupling end portion 123 of the inlet conduit 12, a free end of the unlocking member 126 separates the elastic supporting fragments 121 from the water supply pipe 2, whereby it is possible to easily decouple the water supply pipe 2 from the inlet conduit 12. At this time, due to the fact that the elastic supporting fragments 121 of the pipe fastening member 122 are stably held by the inclined surface of the holder 129, the pipe fastening member 122 is kept from being released from the shoulder 127 of the fixing cap 124.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A fluid treatment apparatus comprising:
a manifold including (a) a housing having inlet and outlet passages, (b) a first fitting mechanism provided in the housing and having a first fitting portion and valve means for controlling fluid flow through the inlet passage, and (c) a second fitting mechanism provided in a center portion of the first fitting mechanism and having a second fitting portion and a first flow path which is communicated with the outlet passage of the housing; and
a filter cartridge having (a) a flow space for receiving fluid from the inlet passage through the valve means of the first fitting mechanism, filtering fluid by a filtering substance and then discharging filtered fluid through the first flow path into the outlet passage, and (b) first and second flanges into which the first and second fitting portions of the first and second fitting mechanisms are fitted, respectively;
wherein (a), when the filter cartridge is coupled to the manifold, a valve member of the valve means of the first fitting mechanism is brought into contact with an upper end surface of the second flange, and thereby, the valve means is opened to allow fluid to flow into the filter cartridge, be filtered by the filtering substance and then be discharged through the first flow path of the second fitting mechanism into the outlet passage of the housing; and (b), when the filter cartridge is decoupled from the manifold, the valve member of the valve means of the first fitting mechanism shuts off fluid flow from the inlet passage into the filter cartridge.

2. The fluid treatment apparatus as set forth in claim 1, wherein the housing further has a reservoir which is communicated with the outlet passage, filtering means which is provided in the reservoir, and a second flow path which is defined to allow fluid communication between the inlet passage and the reservoir; and, when the filter cartridge is decoupled from the manifold, the valve member of the valve means shuts off fluid communication between the inlet passage and the filter cartridge, and allows fluid communication between the inlet passage and the second flow path, whereby fluid can directly flow from the inlet passage through the second flow path into the reservoir of the housing while not passing through the filter cartridge.

3. A fluid treatment apparatus comprising:
a manifold including (a) a housing having inlet and outlet passages, (b) a first fitting mechanism provided in the housing and having a first fitting portion and first valve means for controlling fluid flow through the inlet passage, and (c) a second fitting mechanism slidably inserted into a center bore of the first fitting mechanism and having a second fitting portion, second valve means and a first flow path which is communicated with the outlet passage of the housing; and
a filter cartridge having (a) a flow space for receiving fluid from the inlet passage through the first valve means of the first fitting mechanism, filtering fluid by a filtering substance and then discharging filtered fluid through the first flow path into the outlet passage, and (b) first and second flanges into which the first and second fitting portions of the first and second fitting mechanisms are fitted, respectively;
wherein (a), when the filter cartridge is coupled to the manifold, a valve member of the first valve means of the first fitting mechanism is brought into contact with an upper end surface of the second flange and thereby the first valve means is opened, and the second valve means of the second fitting mechanism is opened, to allow fluid to flow into the filter cartridge, be filtered by the filtering substance and then be discharged through the first flow path of the second fitting mechanism into the outlet passage of the housing; and (b), when the filter cartridge is decoupled from the manifold, the valve member of the first valve means of the first fitting mechanism closes the first valve means to shut off fluid flow from the inlet passage into the filter cartridge, and the second valve means of the second fitting mechanism is closed to block the first flow path.

4. The fluid treatment apparatus as set forth in claim 3, wherein (a) the second valve means of the second fitting mechanism includes a valve head which extends from the second fitting portion, a valve stem which has an exit aperture communicated with the outlet passage, and a cylinder which guides sliding movement of the valve head and valve stem and prevents release of the valve head and valve stem from the center bore of the first fitting mechanism; (b), when the filter cartridge is coupled to the manifold, a valve member, of the second valve means is slidingly moved inward of the center bore of the first fitting mechanism along the cylinder to allow communication between the exit aperture and the outlet passage; and (c), when the filter cartridge is decoupled from the manifold, the valve member of the second valve means is slidingly moved outward of the center bore of the first fitting mechanism along the cylinder to shut off communication between the exit aperture and the outlet passage.

5. The fluid treatment apparatus as set forth in claim 4, wherein the valve head of the valve member of the second valve means is formed, on a circumferential outer surface thereof, with a guide projection, and the cylinder is formed, on a circumferential inner surface thereof, with a stopper projection, in a manner such that, when the filter cartridge is decoupled from the manifold, release of the valve member of the second valve means from the cylinder is prevented by engagement between the guide and stopper projections.

6. The fluid treatment apparatus as set forth in claim 3, wherein the housing further has defined therein a second flow path for allowing fluid communication between the inlet and outlet passages; and, when the filter cartridge is decoupled from the manifold, the valve member of the first valve means shuts off fluid communication between the inlet passage and the filter cartridge, and opens the second flow path to allow fluid communication between the inlet passage and the second flow path in a manner such that fluid can directly flow from the inlet passage through the second flow path into the outlet passage of the housing while not passing through the filter cartridge.

7. The fluid treatment apparatus as set forth in claim 4, wherein the housing further has defined therein a second flow path for allowing fluid communication between the inlet and outlet passages; when the filter cartridge is coupled to the manifold, the second flow path is communicated with the first flow path of the second fitting mechanism through the exit aperture defined in the valve stem of the second valve means of the second fitting mechanism; and, when the filter cartridge is decoupled from the manifold, the first valve means of the first fitting mechanism shuts off fluid flow from the inlet passage into the filter cartridge, the second valve means of the second fitting mechanism shuts off fluid communication between the first and second flow paths, and fluid flows from the inlet passage through the second flow path into the outlet passage while not passing through the filter cartridge.

8. The fluid treatment apparatus as set forth in claim 7, wherein the housing further has defined therein a reservoir which is communicated with the inlet passage via the second flow path.

9. The fluid treatment apparatus as set forth in claim 8, wherein filtering means is provided in the reservoir of the housing.
